(19) United States
(12) Patent Application Publication
(10) Pub. No.: US 2016/0104243 A1
(43) Pub. Date: Apr. 14, 2016

(54) Methods and Apparatus for Facilitating Investor Education

(71) Applicant: Omar Besim Hakim, Austin, TX (US)

(72) Inventor: Omar Besim Hakim, Austin, TX (US)

(21) Appl. No.: 14/105,618

(22) Filed: Dec. 13, 2013

Related U.S. Application Data
(60) Provisional application No. 61/737,619, filed on Dec. 14, 2012.

(51) Int. Cl. G06Q 40/06; G09B 19/18

(52) U.S. Cl. CPC G06Q 40/06

(57) ABSTRACT

Methods and apparatus for facilitating investor education are disclosed. In one embodiment, an education service is provided to investors in an investment. Vetting information regarding investment targets of the investment entity is provided to the set of investors. Responsive to receiving investment decision input from ones of the set of investors, investment decision instructions are provided to the investment entity with respect to the investment targets.

This application claims benefit of priority to U.S. Provisional Application Ser. No. 61/737,619, filed Dec. 14, 2012.

### BACKGROUND

### Description of the Related Art

The growth of various platforms for facilitating investment in early-stage companies has created opportunities for affluent and sophisticated parties to make large investments in startup businesses. While these platforms are of benefit to both the companies receiving the investment necessary to grow and to the investors participating in a potential source of wealth accumulation, the platforms suffer from a series of very real limitations.

First and foremost among these limitations is the exclusion of less affluent investors. An angel investor or angel (also known as a business angel or informal investor) is typically an affluent individual who provides capital for a business start-up, usually in exchange for convertible debt or ownership equity. A small but increasing number of angel investors organize themselves into angel groups or angel networks to share research and pool their investment capital, as well as to provide advice to their portfolio companies. Frequently, angel investor groups require a minimum level of net worth (e.g., $1M in 2012 USD) to gain admission. The requirement for $1M in net worth excludes all but the wealthiest 8% of American households from this potential source of wealth accumulation.

Additionally, and perhaps more importantly in the long run, effective platform exists for teaching potential investors the skills necessary to intelligently invest in early-stage companies. The angel investment model assumes that individuals having met the required level of affluence will also possess the sophisticated financial assessment skills necessary to understand the condition and prospect of an early-stage business before investing. Unfortunately, a realistic experience of the human condition suggests that affluence is not necessarily correlated sophisticated financial assessment skills, and the lack of any accessible platform for gaining those skills limits the ability of many individuals to participate in this potential source of wealth accumulation.

### SUMMARY

Methods and apparatus for facilitating the education of investors are disclosed. In one embodiment, an education service is provided to investors in an investment. Vetting information regarding investment targets of the investment entity is provided to the set of investors. Responsive to receiving investment decision input from ones of the set of investors, investment decision instructions are provided to the investment entity with respect to the investment targets.

### BRIEF DESCRIPTION OF THE DRAWINGS

FIG. 1 illustrates an ecosystem architecture for facilitating investor education, according to some embodiments.

FIG. 2 depicts a system architecture for facilitating investor education, according to some embodiments.

FIG. 3 illustrates a module that that may be used for implementing facilitating investor education, according to some embodiments.

FIG. 4 is a high-level logical flowchart of operations that can be used to facilitate investor education in some embodiments.

FIG. 5 is a high-level logical flowchart of operations that can be used to facilitate investor education in some embodiments.

FIG. 6 is a high-level logical flowchart of operations that can be used to facilitate investor education in some embodiments.

FIG. 7 illustrates an ecosystem architecture for facilitating investor education, according to some embodiments.

FIG. 8 depicts a system architecture for facilitating investor education, according to some embodiments.

FIG. 9 illustrates an ecosystem architecture for facilitating investor education, according to some embodiments.

FIG. 10 illustrates an example computer system that may be used in embodiments.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean “including, but not limited to”.

### DETAILED DESCRIPTION OF EMBODIMENTS

Some embodiments provide methods and apparatus for facilitating investor education. In some embodiments, an investor education course is provided, and a series of investment opportunities are presented to the investors as practical illustrations of the investor education skills that are taught. The investors participate in the management of an entity implementing investment decisions. In some embodiments, participation takes the form of voting on whether the entity should invest in the opportunities that are presented.

### Brief Explanation of Technical Terms

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

While some processes or operations described herein are described as being performed by a particular module or modules, one of skill in the art will readily discern in light of having read the present disclosure that such operations or process may be performed by other modules or that modules and their functions may be distributed to computing systems other than those shown (e.g., executing on a client while shown herein on a server) without departing from the scope and intent of the present disclosure. Likewise, while some process are presented as a series of operations and are explained in a particular order, one of skill in the art will readily discern in light of having read the present disclosure that such operations or processes may be performed in an alternative order or combination without departing from the scope and intent of the present disclosure. Embodiments will combine, omit, and substitute modules and the operations that they perform or execute without departing from the scope and intent of the present disclosure. In the discussion contained herein, embodiments are described as performing operations, transactions, financial transactions or procedures, which may be taken to mean both performing an operation or procedure directly or supporting that operation or procedure through the processing or preparation of data for that operation or procedure. Likewise, as used herein, performing includes transmitting data or preparing data for transmission to another device for performance of the operation.

While a processor is generally understood to mean a microprocessor or other computing apparatus, some embodiments of the present invention support human processing (e.g., pen and paper recording and allocating) to execute the steps described. Some embodiments may be implemented by a computer processor supporting human intervention and non-transitory media, such as a human processor using a computer, the Internet, a website, a smartphone or calculator to assist with pen and paper recording and allocating or computer-based recording and allocating. In some embodiments, a hybrid approach, such as crowd sourcing of a distributed task using a microprocessor based supervision system and a plurality of human processors (e.g., Amazon.com Mechanical Turk™) may perform the operations described herein.

### Introduction to Investor Education

Various embodiments of methods and apparatus for facilitating investor education are disclosed. Some embodiments perform providing an education service to investors in an investment entity, providing to the set of investors vetting information regarding investment targets of the investment entity, responsive to receiving investment decision input from ones of the set of investors, and providing investment decision instructions to the investment entity with respect to the investment targets. Additionally, some investments further perform providing to the set of investors investment reports regarding investments in the investment targets of the investment entity.

In some embodiments, the providing to the set of investors the vetting information regarding the investment targets of the investment entity further includes providing to the set of investors vetting information received from another investment entity. In some embodiments, the providing to the set of investors the vetting information regarding the investment targets of the investment entity further includes providing to the set of investors vetting information received from an angel network that is facilitating investing in startup companies, and the providing investment decision instructions to the investment entity with respect to the investment targets further includes providing investment decision instructions to a sidecar investment entity with respect to the startup companies.

In some embodiments, the providing the education service to the investors in the investment entity further includes providing an online course series to the investors in an investment entity. In some embodiments, the receiving investment decision input from one of the set of investors further includes receiving votes from the ones of the set of investors regarding investment decision instructions for the investment entity to make investments in the investment targets. In some embodiments, the providing the education service to the investors in the investment entity further includes providing an online course series to the investors in an investment entity. The providing the online course series further includes providing a video series explaining investing concepts and a series of interactive measurement instruments for measuring mastery of concepts presented in the online course series.

Some embodiments may include a means for facilitating investor education. Some embodiments may include an investment management and education module for facilitating investor education, as described herein. In some embodiments, the module may perform providing an education service to investors in an investment entity, providing to the set of investors vetting information regarding investment targets of the investment entity, and, responsive to receiving investment decision input from ones of the set of investors, providing investment decision instructions to the investment entity with respect to the investment targets, as described herein. Additionally, in some embodiments, the investment management and education module further performs providing to the set of investors investment reports regarding investments in the investment targets of the investment entity, as described herein.

In some embodiments, the investment management and education module providing to the set of investors the vetting information regarding the investment targets of the investment entity further includes the investment management and education module providing to the set of investors vetting information received from another investment entity, as described herein. In some embodiments, the investment management and education module providing to the set of investors the vetting information regarding the investment targets of the investment entity further includes the investment management and education module providing to the set of investors vetting information received from an angel network that is facilitating investing in startup companies, and the investment management and education module providing investment decision instructions to the investment entity with respect to the investment targets further includes the investment management and education module providing investment decision instructions to a sidecar investment entity with respect to the startup companies, as described herein.

In some embodiments, the investment management and education module providing the education service to the investors in the investment entity further includes the investment management and education module providing an online course series to the investors in an investment entity, as described herein. In some embodiments, the investment management and education module receiving investment decision input from one of the set of investors further includes the investment management and education module receiving votes from the ones of the set of investors regarding investment decision instructions for the investment entity to make investments in the investment targets, as described herein. In some embodiments, the investment management and education module providing the education service to the investors in the investment entity further includes the investment management and education module providing an online course series to the investors in an investment entity, as described herein. The investment management and education module providing the online course series further includes the investment management and education module providing a video series explaining investing concepts and a series of interactive measurement instruments for measuring mastery of concepts presented in the online course series, as described herein

The investment management and education module may in some embodiments be implemented by a non-transitory, computer-readable storage medium and one or more processors (e.g., CPUs and/or GPUs) of a computing apparatus. The computer-readable storage medium may store program instructions executable by the one or more processors to cause the computing apparatus to perform providing an education service to investors in an investment entity, providing to the set of investors vetting information regarding investment targets of the investment entity, and, responsive to receiving investment decision input from ones of the set of investors, providing investment decision instructions to the investment entity with respect to the investment targets, as described here. Other embodiments of the transaction management module may be at least partially implemented by hardware circuitry and/or firmware stored, for example, in a non-volatile memory.

### Example Implementations

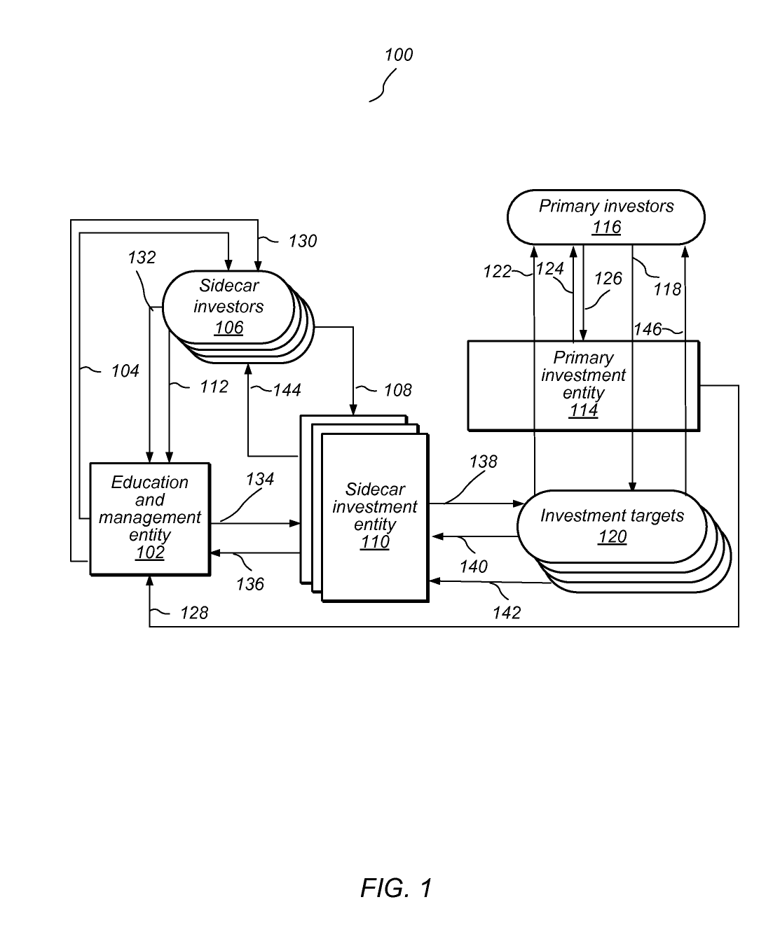

FIG. 1 illustrates an ecosystem architecture for facilitating investor education, according to some embodiments. Investment ecosystem 100 includes an education and management entity 102 that provides investment education services 104 to sidecar investors 106. Upon becoming associated with education and management entity 102, sidecar investors 106 provide sidecar investment funds 108 to sidecar investment entity 110 and education and management payments 112 to education and management entity 102.

Sidecar investment entity 110 and education and management entity 102 operate in conjunction with a primary investment entity 114. Primary investment entity 114 facilitates the ability of primary investors 116 to provide primary capital 118 to investment targets 120 in exchange for payment obligations 122. Primary investment entity 114 facilitates the ability of primary investors 116 to provide primary capital 118 to investment targets 120 in exchange for primary payment obligations 122 by providing primary investment vetting and reporting information 124 in exchange for primary fees 126. When investment targets 120 provide primary investment payments 146 to primary investors 116, those primary investment payments 146 may or may not flow through primary investment entity 114.

In addition to providing investment education services 104 to sidecar investors 106, education and management entity 102 receives sidecar investment vetting and reporting information 128 from primary investment entity 114. Education and management entity 102 then provides sidecar investment vetting and reporting information 130 to sidecar investors 106 and receives investment decision input 132 from sidecar investors 106. Based at least in part upon investment decision input 132 from sidecar investors 106, education and management entity 102 communicates investment decision instructions 134 to sidecar investment entity 110. Education and management entity 102 receives investment reports 136 from sidecar investment entity 110. Sidecar investment entity 110 provides sidecar capital 138 to investment targets 120 in exchange for sidecar payment obligations 140. When investment targets 120 provide sidecar investment payments 142 to sidecar investment entity 110, sidecar investment entity provides sidecar returns 144 to sidecar investors 106.

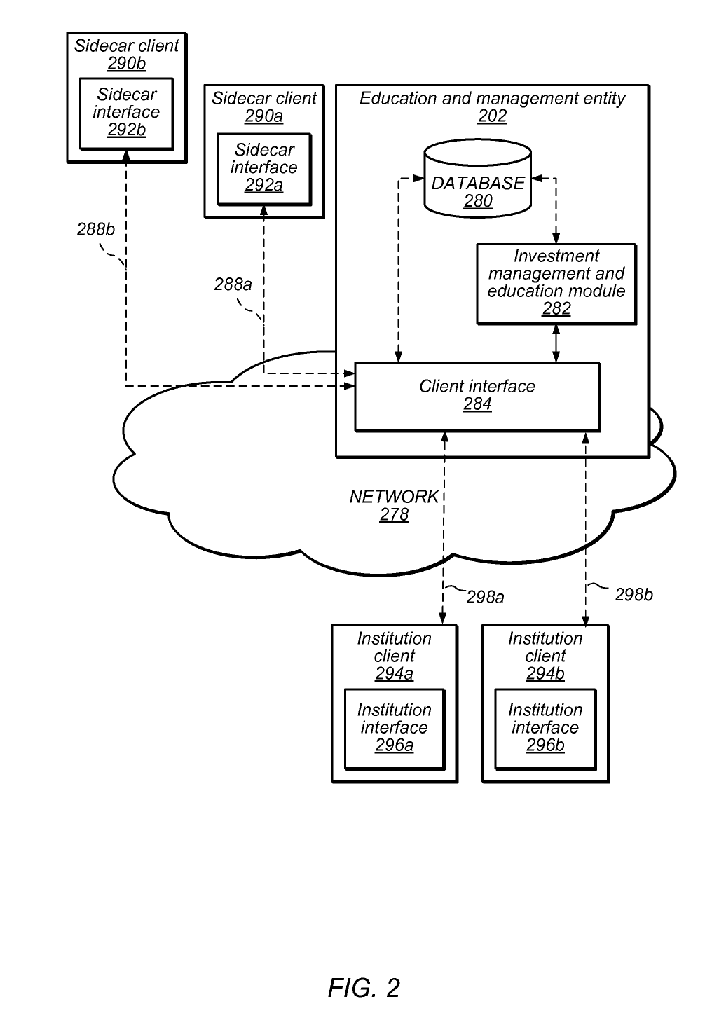

FIG. 2 depicts a system architecture for facilitating investor education, according to some embodiments. In some embodiments, an education and management entity 202 performs functions for tracking, managing and facilitating investor education. In some embodiments, an investment management and education module 282 executes instructions for tracking, managing and reporting transactions that include providing an education service to investors in an investment entity, providing to the set of investors vetting information regarding investment targets of the investment entity, responsive to receiving investment decision input from ones of the set of investors, and providing investment decision instructions to the investment entity with respect to the investment targets.

Additionally, in some embodiments, a client interface 284 is used for providing an education service to investors in an investment entity, providing to the set of investors vetting information regarding investment targets of the investment entity, responsive to receiving investment decision input from ones of the set of investors, and providing investment decision instructions to the investment entity with respect to the investment targets, such as over a network 278.

For example, client interface 284 may enable communications 288a-b with sidecar interfaces 292a-b on sidecar clients 290a-b. In some embodiments, sidecar clients 290a-b are computing machines (tablet computers, phones, or conventional desktop or laptop computers) owned by investors, and sidecar interfaces 292a-292b are web pages or applications for providing an education service (e.g., via as a distance education course over communications 288a-288b) to investors in an investment entity represented by education and management entity 202. In some embodiments, providing to the set of investors vetting information regarding investment targets of the investment entity, is also performed by sending communications 288a-288b to sidecar interfaces 292a-b on sidecar clients 290a-b containing vetting information regarding investment targets of the investment entity.

In some embodiments, investment decision input (votes on investment decisions) is sent from investors as content of communications 288a-288b from sidecar interfaces 292a-b on sidecar clients 290a-b to investment management and education module 282 via client interface 284. Responsive to receiving investment decision input from ones of the set of investors, investment management and education module 282 provides investment decision instructions to the investment entity with respect to the investment targets in communications 298a-298b to institution interfaces 296a on institution clients 294, such as over a network 278. In some embodiments, institution clients 290a-b are computing machines (tablet computers, phones, or conventional desktop or laptop computers) owned by an investment entity, and institution interfaces 298a-298b are web pages or applications for communicating between an investment entity and investment and management entity 202.

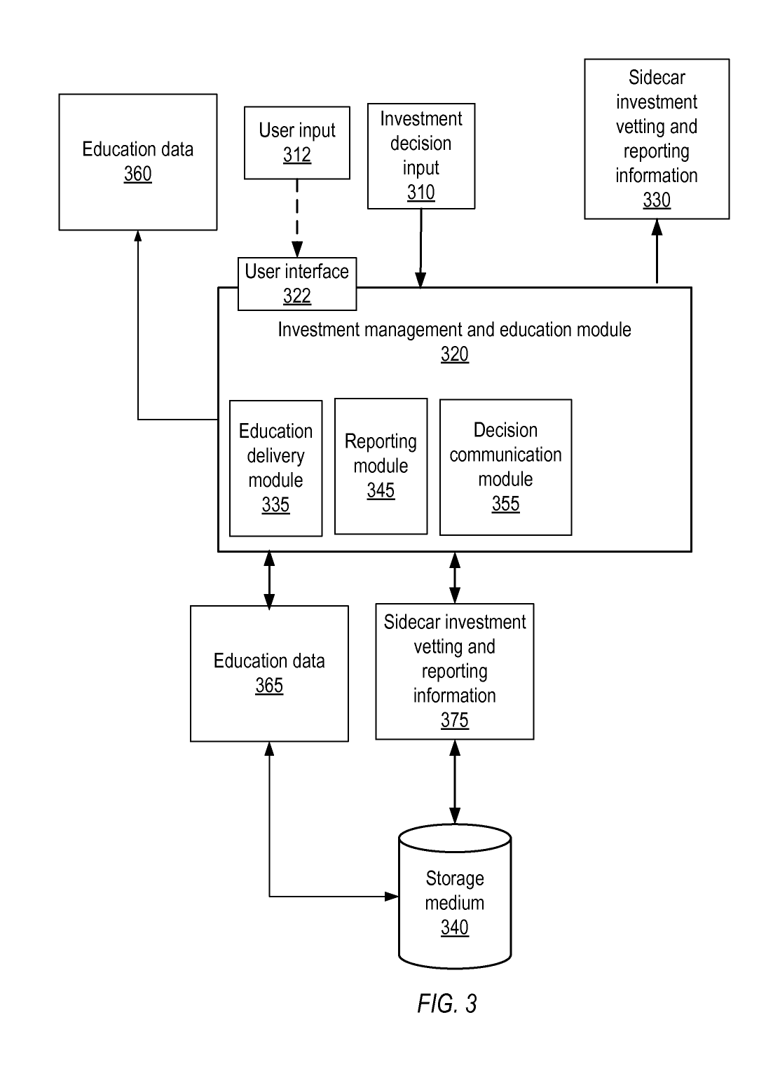

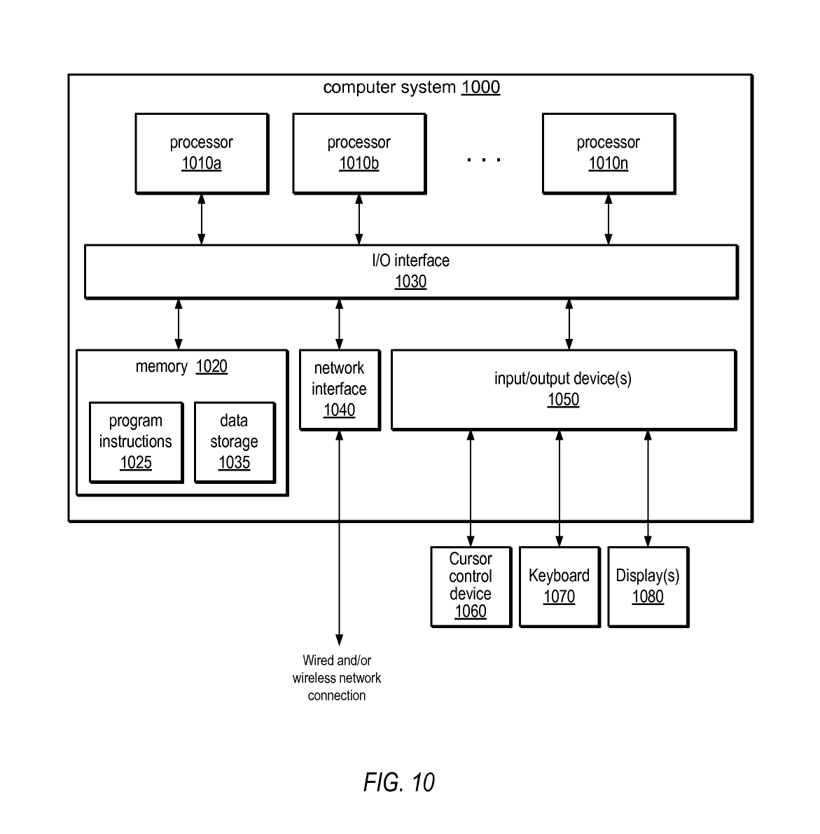

FIG. 3 illustrates a module that that may be used for implementing facilitating investor education, according to some embodiments. Investment management and education module 320 performs various functions for facilitating investor education. FIG. 10 illustrates an example computer system on which embodiments of investment management and education module 320 may be implemented. An education delivery module 335 performs providing an education service to investors in an investment entity, such as by providing education data 360, which could include course materials, video lectures, assessment instruments, and the like.

A decision communication module performs 355 performs providing to the set of investors vetting information regarding investment targets of the investment entity, such as sidecar investment vetting and reporting information 330. Decision communication module performs 355 receiving investment decision input 310 from ones of the set of investors. Responsive to receiving investment decision input 310 from ones of the set of investors, decision communication module 335 performs providing investment decision instructions to the investment entity with respect to the investment targets. A reporting module 345 performs providing to the set of investors investment reports regarding investments in the investment targets of the investment entity, which may be part of sidecar investment vetting and reporting information 330.

In some embodiments, the providing to the set of investors the vetting information regarding the investment targets of the investment entity further includes providing to the set of investors vetting information received from another investment entity, such as sidecar investment vetting and reporting information 375. In some embodiments, sidecar investment vetting and reporting information 375 is received from an angel network that is facilitating investing in startup companies, and decision communication module 335 providing investment decision instructions to the investment entity with respect to the investment targets further includes decision communication module 335 providing investment decision instructions to a sidecar investment entity with respect to the startup companies.

In some embodiments, the providing the education service to the investors in the investment entity further includes providing an online course series to the investors in an investment entity as education data 360. In some embodiments, the receiving investment decision input 310 from one of the set of investors further includes receiving votes from the ones of the set of investors regarding investment decision instructions for the investment entity to make investments in the investment targets. In some embodiments, the providing the education service to the investors in the investment entity further includes providing an online course series to the investors in an investment entity as education data 360. The providing the online course series as education data 360 further includes providing a video series explaining investing concepts and a series of interactive measurement instruments for measuring mastery of concepts presented in the online course series as education data 360.

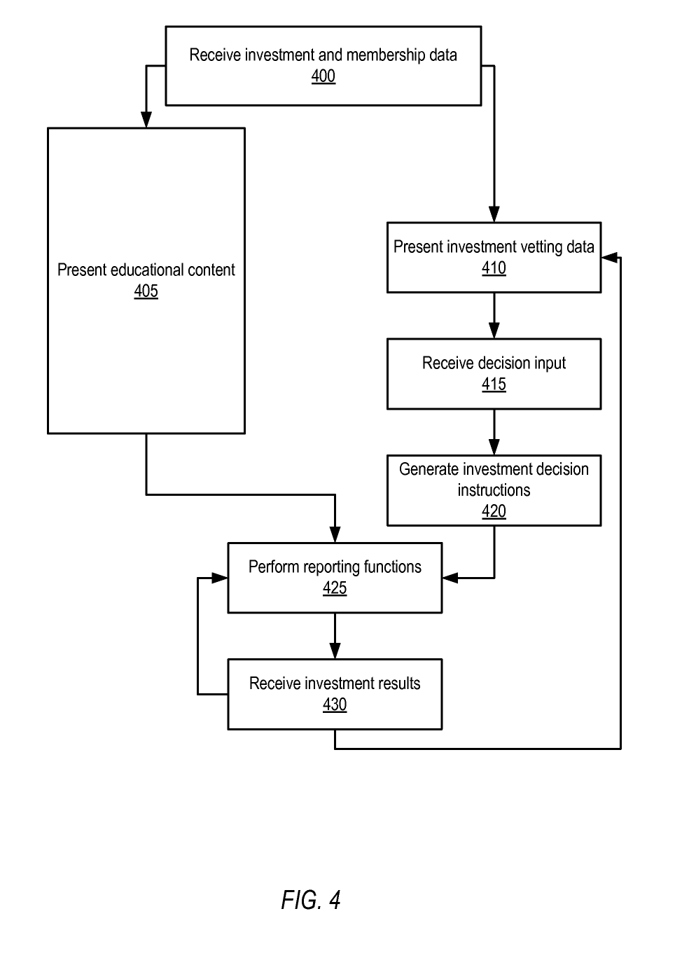

FIG. 4 is a high-level logical flowchart of operations that can be used to facilitate investor education in some embodiments. Initially, investment and membership data is received (block 400). Educational content is presented (block 405). Separately, investment vetting data is presented (block 410). Decision input is received (block 415). Investment decision instructions are generated (block 420). Reporting functions are performed (block 425). Investment results are received (block 430). The process then returns to block 410, which is described above.

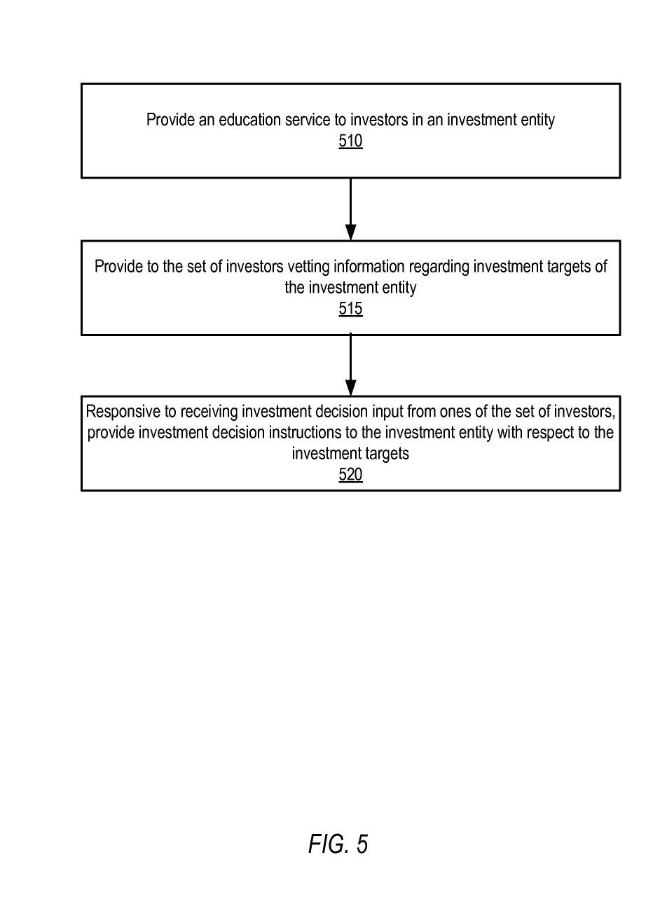

FIG. 5 is a high-level logical flowchart of operations that can be used to facilitate investor education in some embodiments. An education service is provided to investors in an investment entity (block 510). Vetting information regarding investment targets of the investment entity is provided to the set of investors (block 515). Responsive to receiving investment decision input from ones of the set of investors, investment decision instructions are provided to the investment entity with respect to the investment targets (block 520).

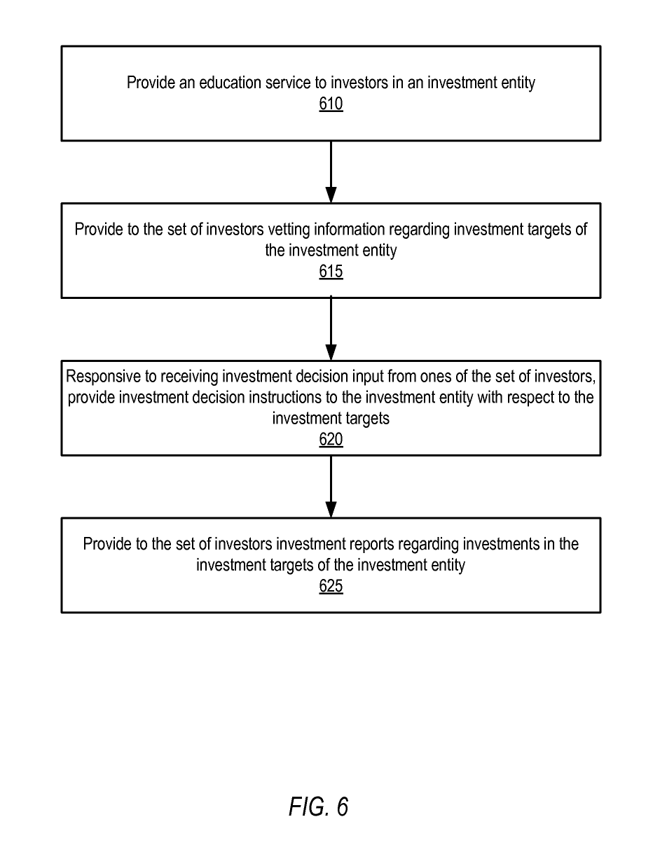

FIG. 6 is a high-level logical flowchart of operations that can be used to facilitate investor education in some embodiments. An education service is provided to investors in an investment entity (block 610). Vetting information regarding investment targets of the investment entity is provided to the set of investors (block 615). Responsive to receiving investment decision input from ones of the set of investors, investment decision instructions are provided to the investment entity with respect to the investment targets (block 620). Investment reports regarding investments in the investment targets of the investment entity is provided to investors (block 625).

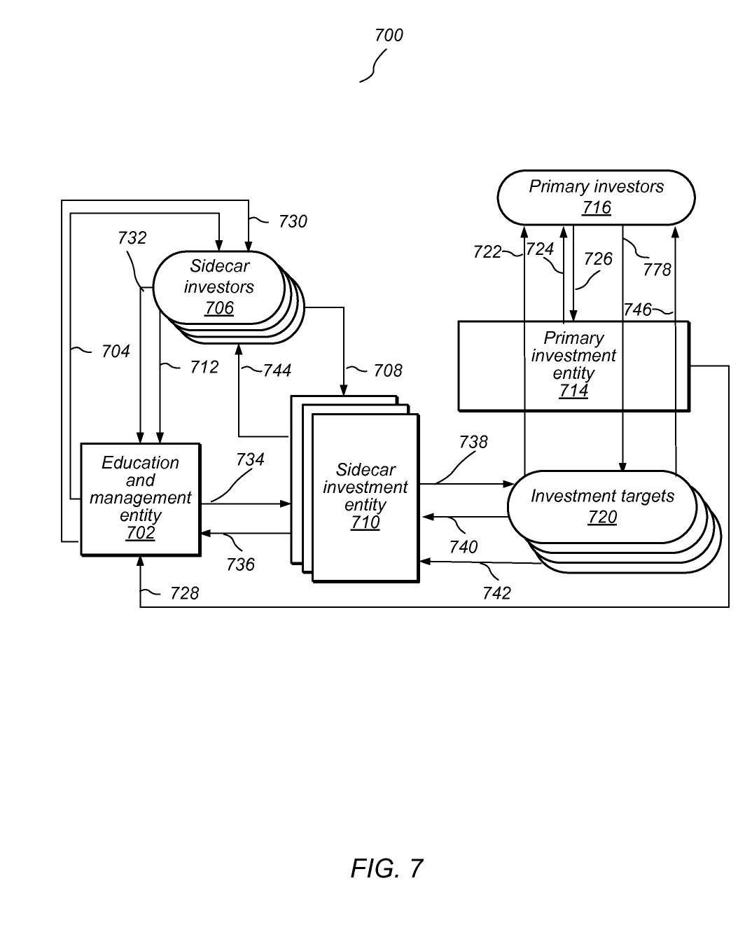

FIG. 7 illustrates an ecosystem architecture for facilitating investor education, according to some embodiments. Investment ecosystem 700 includes an education and management entity 702 that provides investment education services 704 to sidecar investors 706. In one embodiment, education and management entity 702 provides an educational curriculum including education modules (e.g., online and classroom lecture courses), lab exercises consisting of reviews and vetting of investment targets 720, and assessment exercises such as online examinations and certification to sidecar investors 706.

Upon becoming associated with education and management entity 702, sidecar investors 706 provide sidecar investment funds 708 to sidecar investment entity 710 and education and management payments 712 to education and management entity 702. In one embodiment, sidecar investors 706 provide sidecar investment funds 708 to sidecar investment entity 710 in the amount of $1000.00. In one such embodiment, sidecar investment entity 710 is an annually-raised sidecar investment fund raising up to $1M from 1000 investors, each with net worth and annual income below $100,000.00, at $1000.00 investment each. In some embodiments, sidecar investors 706 provide sidecar investment funds 708 to sidecar investment entity 710 in the amount of $1000.00 using an online payment system provided by education and management entity 702 or by a third party provider. Alternatively, sidecar investment entity 710 is an annually-raised sidecar investment fund raising up to $1M from non-accredited investors in different amounts, such as limits ranges from 2% of people earning (or worth) up to $40,000, up to a cap of $10,000 for people earning (or worth) $100,000 or more, while primary investment entity 714 is an angel investment group open to accredited investors. In some embodiments, education and management entity 702 provides services to multiple sidecar investment entities 710, either in series or in parallel.

In some embodiments, one advantage of sidecar investment entity 710 and education and management entity 702 is that education and management entity 702 and sidecar investment entity 710 can serve as a vehicle for enabling large numbers of small investors to participate in funding investment targets 720 with consolidated ownership of stakes in investment targets 720 in sidecar investment entity 710, such that regulatory reporting from investment targets 720 is supplied to sidecar investment entity 710 and education and management entity 702, rather than to all of sidecar investors 706. In such embodiments, education and management entity 702 supplies reporting to sidecar investors 706, who are thereby relieved of the burden of receiving communications from all of investment targets 720. In one embodiment, education and management entity 702 receives education and management payments 712 using an online payment system provided by education and management entity 702 or by a third party provider in the amount of $300-$500 for every $1000 invested in sidecar investment entity 710. In some embodiments, sidecar investment entity 710 has a maximum of 500 “unaccredited” shareholders, or 2,000 total shareholders, including both accredited and unaccredited shareholders. In some embodiments, sidecar investment entity 710 qualifies for exemption from the requirement to register public offerings with the SEC, for certain types of small offerings, subject to several conditions and investment and management entity 702 provides an internet “funding portals” registered with the government.

Sidecar investment entity 710 and education and management entity 702 operate in conjunction with a primary investment entity 714. In one embodiment, primary investment entity 714 is an angel network, which may also be administered, in some embodiments, by education and management entity 702. In such an embodiment, primary investors 716 are angel investors. An angel investor or angel (also known as a business angel or informal investor) is an affluent individual who provides capital for a business start-up, usually in exchange for convertible debt or ownership equity. A small but increasing number of angel investors organize themselves into angel groups or angel networks to share research and pool their investment capital, as well as to provide advice to their portfolio companies. Angels typically invest their own funds, unlike venture capitalists, who manage the pooled money of others in a professionally-managed fund.

Although typically reflecting the investment judgment of an individual, the actual entity that provides the funding may be a trust, business, limited liability company, investment fund, or other vehicle. Evidence exists that angel-funded startup companies have historically been less likely to fail than companies that rely on other forms of initial financing.

Angel capital fills the gap in start-up financing between “friends and family” who provide seed funding—and formal venture capital. Although it is usually difficult to raise more than a few hundred thousand dollars from friends and family, most traditional venture capital funds are usually not able to make or evaluate small investments under US$1-2 million.

Thus, angel investment is a common second round of financing for high-growth start-ups, and accounts in total for almost as much money invested annually as all venture capital funds combined, but into more than 60 times as many companies (US$20.1 billion vs. $23.26 billion in the US in 2010, into 61,900 companies vs. 1,012 companies).

Of the US companies that received angel funding in 2007, the average capital raised was about US$450,000. However, there is no “set amount” for angel investors, and the range can go anywhere from a few thousand, to a few million dollars.

Angel financing, while more readily available than venture financing, is still extremely difficult to raise. Some embodiments alleviate the difficulty in raising angel financing by using sidecar investment entity 710 and education and management entity 702 access sidecar investors at lower levels of net worth and income than the traditional accredited investors represented by primary investors 716.

Angel investments, including those made by embodiments employing sidecar investment entity 710, bear extremely high risk and are usually subject to dilution from future investment rounds.

As such, a very high return on investment is desired, and one advantage of some embodiments is that the use of sidecar investment entity 710 and education and management entity 702 in conjunction with primary investment entity 714 is that the due diligence necessary to satisfy primary investors 716, who are typically more sophisticated than sidecar investors 706, is reported to sidecar investors 706. Because a large percentage of angel investments are lost completely when early stage companies fail, professional angel investors such as primary investors 716 frequently seek investments that have the potential to return at least 10 or more times their original investment within 5 years, through a defined exit strategy, such as plans for an initial public offering or an acquisition, which can trigger distributions from investment targets 720 to sidecar investment entity 710 and then to sidecar investors 706.

Current ‘best practices’ suggest that angels might do better setting their sights even higher, looking for companies that will have at least the potential to provide a 20×-30× return over a five- to seven-year holding period. After taking into account the need to cover failed investments and the multi-year holding time for even the successful ones, however, the actual effective internal rate of return for a typical successful portfolio of angel investments is, in reality, typically as ‘low’ as 20-30%. While the investor's need for high rates of return on any given investment can thus make angel financing an expensive source of funds, cheaper sources of capital, such as bank financing, are usually not available for most early-stage ventures such as investment targets 720, which may be too small or young to qualify for traditional loans.

Primary investment entity 714 facilitates the ability of primary investors 716 to provide primary capital 718 to investment targets 720 in exchange for payment obligations 722, usually convertible debt or ownership equity. Primary investors are frequently retired entrepreneurs or executives, who may be interested in angel investing for reasons that go beyond pure monetary return. These include wanting to keep abreast of current developments in a particular business arena, mentoring another generation of entrepreneurs, and making use of their experience and networks on a less than full-time basis. Thus, in addition to funds, angel investors can often provide valuable management advice and important contacts that would not conventionally be available to sidecar investors 706 or investment targets 720, and some embodiments facilitate the transmission of this sort of advice and contacts between primary investors 716 and sidecar investors 716 through investment and management entity 702. Angel groups are generally local organizations made up of 10 to 150 accredited investors (primary investors 716) interested in early-stage investing.

Primary investment entity 714 facilitates the ability of primary investors 716 to provide primary capital 718 to investment targets 720 in exchange for primary payment obligations 722 by providing primary investment vetting and reporting information 724 in exchange for primary fees 726, which may be provided to education and management entity 702 if management services for primary investment entity 714 are provided by education and management entity 702. When investment targets 720 provide primary investment payments 746 to primary investors 716, those primary investment payments 746 may or may not flow through primary investment entity 714.

In addition to providing investment education services 704 to sidecar investors 106, education and management entity 702 receives sidecar investment vetting and reporting information 728 from primary investment entity 714. Education and management entity 702 then provides sidecar investment vetting and reporting information 730 to sidecar investors 706 and receives investment decision input 732 from sidecar investors 706. Based at least in part upon investment decision input 732 from sidecar investors 706, education and management entity 702 communicates investment decision instructions 734 to sidecar investment entity 710. Education and management entity 702 receives investment reports 736 from sidecar investment entity 710. Sidecar investment entity 710 provides sidecar capital 738 to investment targets 720 in exchange for sidecar payment obligations 740. When investment targets 720 provide sidecar investment payments 742 to sidecar investment entity 710, sidecar investment entity provides sidecar returns 744 to sidecar investors 706.

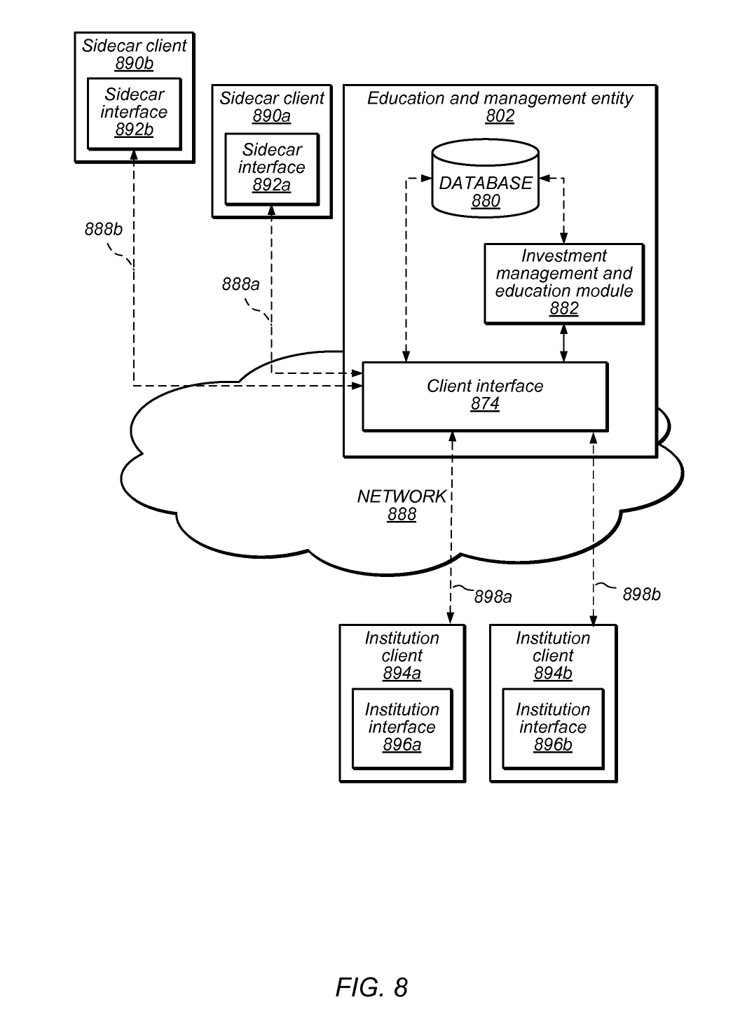

FIG. 8 depicts a system architecture for facilitating investor education, according to some embodiments. In some embodiments, an education and management entity 802 performs functions for tracking, managing and facilitating investor education. For example, education and management entity 802 performs the day-to-day operations of an angel network or an associated sidecar investment entity, or both. Some embodiments of education and management entity 802 comply with the requirements of JOBS Act, signed into law on Apr. 5, 2012 as well as subsequent amendments and implementing rules.

In some embodiments, an investment management and education module 882 executes instructions for tracking, managing and reporting transactions that include providing an education service to investors in an investment entity, providing to the set of investors vetting information regarding investment targets of the investment entity, responsive to receiving investment decision input from ones of the set of investors, and providing investment decision instructions to the investment entity with respect to the investment targets. In some embodiments, management and education module 882 executes instructions for tracking, managing and reporting transactions to provide an internet “funding portal” registered with the government. In some embodiments, management and education module 882 tracks investments to facilitate crowd funding of a sidecar investment fund, such that exemption from securities laws is secured by tracking transactions to maintain a yearly aggregate limit on the amount each person may invest in offerings of this type, tiered by the person's net worth or yearly income. The limit ranges from 2% of people earning (or worth) up to $40,000, up to a cap of $10,000 for people earning (or worth) $100,000 or more. In some embodiments, management and education module 882 facilitates reviews of financial statements for offerings between $100,000 and $500,000, and audits of financial statements for offerings greater than $500,000 (noting maximum offering of $1,000,000) through the use of database 880. In some embodiments, institution clients 894a are used for auditing and review through institution interface 896a. In some embodiments, investment management and education module 882 provides “general solicitation” and advertising in specific kinds of private placements of securities.

Additionally, in some embodiments, a client interface 884 is used for providing an education service to investors in an investment entity, providing to the set of investors vetting information regarding investment targets of the investment entity, responsive to receiving investment decision input from ones of the set of investors, and providing investment decision instructions to the investment entity with respect to the investment targets, such as over a network 878.

For example, client interface 884 may enable communications 888a-b with sidecar interfaces 292a-b on sidecar clients 890a-b. In some embodiments, sidecar clients 890a-b are computing machines (tablet computers, phones, or conventional desktop or laptop computers) owned by investors, and sidecar interfaces 892a-892b are web pages or applications for providing an education service (e.g., via as a distance education course over communications 288a-288b) to investors in an investment entity represented by education and management entity 802. In some embodiments, providing to the set of investors vetting information regarding investment targets of the investment entity, is also performed by sending communications 888a-888b to sidecar interfaces 892a-b on sidecar clients 890a-b containing vetting information regarding investment targets of the investment entity.

In some embodiments, investment decision input (votes on investment decisions) is sent from investors as content of communications 888a-888b from sidecar interfaces 892a-b on sidecar clients 890a-b to investment management and education module 882 via client interface 884. Responsive to receiving investment decision input from ones of the set of investors, investment management and education module 882 provides investment decision instructions to the investment entity with respect to the investment targets in communications 898a-898b to institution interfaces 896a on institution clients 894, such as over a network 878. In some embodiments, institution clients 890a-b are computing machines (tablet computers, phones, or conventional desktop or laptop computers) owned by an investment entity, and institution interfaces 898a-898b are web pages or applications for communicating between an investment entity and investment and management entity 802.

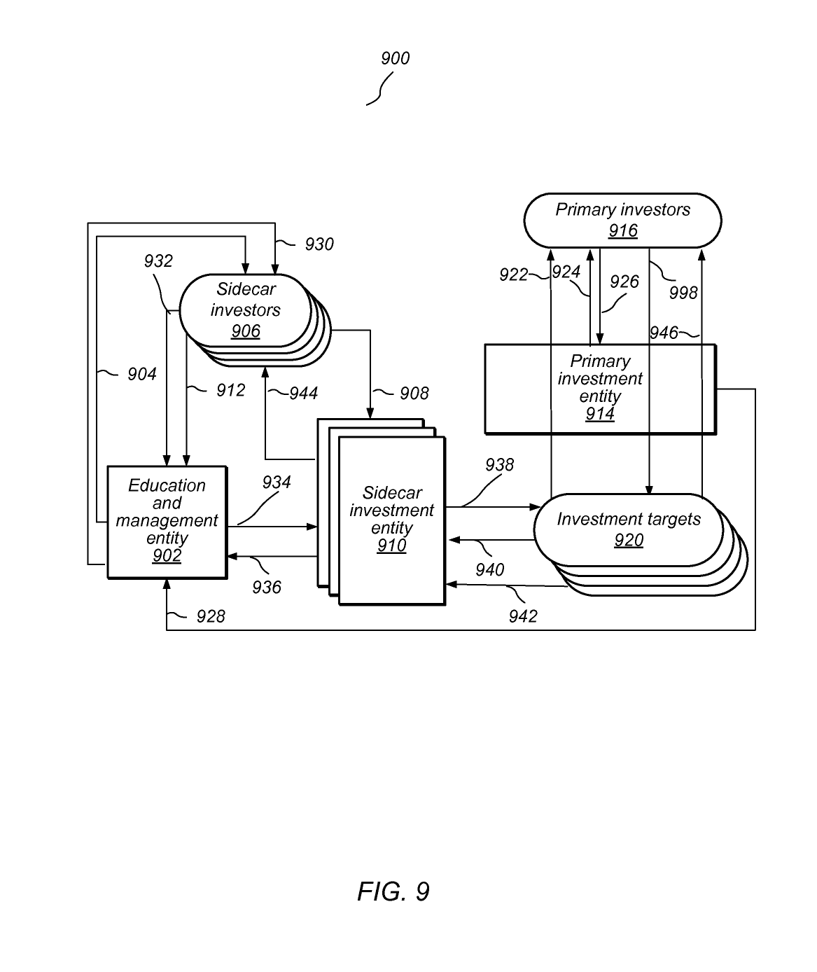

FIG. 9 illustrates an ecosystem architecture for facilitating investor education, according to some embodiments. Investment ecosystem 900 includes an education and management entity 902 that provides investment education services 904 to sidecar investors 906. In one embodiment, education and management entity 902 provides an educational curriculum including education modules (e.g., online and classroom lecture courses), lab exercises consisting of reviews and vetting of investment targets 920, and assessment exercises such as online examinations and certification to sidecar investors 906.

Upon becoming associated with education and management entity 902, sidecar investors 906 provide sidecar investment capital 908 to sidecar investment entity 910 and education and management payments 912 to education and management entity 902. In one embodiment, sidecar investors 906 provide sidecar investment capital 908 to sidecar investment entity 910 in the amount of $1000.00.

In one such embodiment, sidecar investment entity 910 is a sidecar investment clearinghouse raising up to $1M from 1000 investors, each with net worth and annual income below $100,000.00, at $1000.00 investment each. In some such embodiments, such an investment is an allocated stake in allocated contents of a clearinghouse, rather than an investment fund. Such embodiments of sidecar investment entity 910 are not investment funds.

In such embodiments, funds provided to sidecar investment entity 910 are segregated and ownership stakes in particular investments are allocated to particular sidecar investors, rather than being pooled in an investment fund. As such, the investor retains individual control of assets.

In some embodiments, sidecar investors 906 provide sidecar investment capital 908 to sidecar investment entity 910 in the amount of $1000.00 using an online payment system provided by education and management entity 902 or by a third party provider. Alternatively, sidecar investment entity 910 is an sidecar investment clearing house raising up to $1M from non-accredited investors in different amounts, such as limits ranges from 2% of people earning (or worth) up to $40,000, up to a cap of $10,000 for people earning (or worth) $100,000 or more, while primary investment entity 914 is an angel investment group open to accredited investors. In some embodiments, education and management entity 902 provides services to multiple sidecar investment entities 910, either in series or in parallel.

In some embodiments, one advantage of sidecar investment entity 910 and education and management entity 902 is that education and management entity 902 and sidecar investment entity 910 can serve as a vehicle for enabling large numbers of small investors to participate in funding investment targets 920 with consolidated tracking of individual ownership of stakes in investment targets 920 in sidecar investment entity 910, such that regulatory reporting from investment targets 920 is supplied to sidecar investment entity 910 and education and management entity 902, rather than to all of sidecar investors 906. In such embodiments, education and management entity 902 supplies reporting to sidecar investors 906, who are thereby relieved of the burden of receiving communications from all of investment targets 920.

In one embodiment, education and management entity 902 receives education and management payments 912 using an online payment system provided by education and management entity 902 or by a third party provider in the amount of $300-$500 for every $1000 invested using sidecar investment entity 910. In some embodiments, sidecar investment entity 910 has a maximum of 500 “unaccredited” shareholders, or 2,000 total shareholders, including both accredited and unaccredited shareholders. In some embodiments, sidecar investment entity 910 qualifies for exemption from the requirement to register public offerings with the SEC, for certain types of small offerings, subject to several conditions and investment and management entity 902 provides a internet “funding portals” registered with the government.

Sidecar investment entity 910 and education and management entity 902 operate in conjunction with a primary investment entity 914. In one embodiment, primary investment entity 914 is an angel network, which may also be administered, in some embodiments, by education and management entity 902. In such an embodiment, primary investors 916 are angel investors. An angel investor or angel (also known as a business angel or informal investor) is an affluent individual who provides capital for a business start-up, usually in exchange for convertible debt or ownership equity. A small but increasing number of angel investors organize themselves into angel groups or angel networks to share research and pool their investment capital, as well as to provide advice to their portfolio companies. Angels typically invest their own funds, unlike venture capitalists, who manage the pooled money of others in a professionally-managed fund.

Although typically reflecting the investment judgment of an individual, the actual entity that provides the funding may be a trust, business, limited liability company, or other vehicle. Evidence exists that angel-funded startup companies have historically been less likely to fail than companies that rely on other forms of initial financing.

Angel capital fills the gap in start-up financing between “friends and family” who provide seed funding—and formal venture capital. Although it is usually difficult to raise more than a few hundred thousand dollars from friends and family, most traditional venture capital funds are usually not able to make or evaluate small investments under US$1-2 million.

Thus, angel investment is a common second round of financing for high-growth start-ups, and accounts in total for almost as much money invested annually as all venture capital funds combined, but into more than 60 times as many companies (US$20.1 billion vs. $23.26 billion in the US in 2010, into 61,900 companies vs. 1,012 companies).

Of the US companies that received angel funding in 2007, the average capital raised was about US$450,000. However, there is no “set amount” for angel investors, and the range can go anywhere from a few thousand, to a few million dollars.

Angel financing, while more readily available than venture financing, is still extremely difficult to raise. Some embodiments alleviate the difficulty in raising angel financing by using sidecar investment entity 910 and education and management entity 902 access sidecar investors at lower levels of net worth and income than the traditional accredited investors represented by primary investors 916 and to provide consolidated tracking for individually owned investment stakes. In some such embodiments, sidecar investment entity 910 holds no direct ownership of investor stakes.

Angel investments, including those made by embodiments employing sidecar investment entity 910, bear extremely high risk and are usually subject to dilution from future investment rounds.

As such, a very high return on investment is desired, and one advantage of some embodiments is that the use of sidecar investment entity 910 and education and management entity 902 in conjunction with primary investment entity 914 is that the due diligence necessary to satisfy primary investors 916, who are typically more sophisticated than sidecar investors 906, is reported to sidecar investors 906. Because a large percentage of angel investments are lost completely when early stage companies fail, professional angel investors such as primary investors 916 frequently seek investments that have the potential to return at least 10 or more times their original investment within 5 years, through a defined exit strategy, such as plans for an initial public offering or an acquisition, which can trigger distributions from investment targets 920 to sidecar investment entity 910 and then to sidecar investors 906.

Current ‘best practices’ suggest that angels might do better setting their sights even higher, looking for companies that will have at least the potential to provide a 20×-30× return over a five- to seven-year holding period. After taking into account the need to cover failed investments and the multi-year holding time for even the successful ones, however, the actual effective internal rate of return for a typical successful portfolio of angel investments is, in reality, typically as ‘low’ as 20-30%. While the investor's need for high rates of return on any given investment can thus make angel financing an expensive source of funds, cheaper sources of capital, such as bank financing, are usually not available for most early-stage ventures such as investment targets 920, which may be too small or young to qualify for traditional loans.

Primary investment entity 914 facilitates the ability of primary investors 916 to provide primary capital 918 to investment targets 920 in exchange for payment obligations 922, usually convertible debt or ownership equity. Primary investors are frequently retired entrepreneurs or executives, who may be interested in angel investing for reasons that go beyond pure monetary return. These include wanting to keep abreast of current developments in a particular business arena, mentoring another generation of entrepreneurs, and making use of their experience and networks on a less than full-time basis. Thus, in addition to funds, angel investors can often provide valuable management advice and important contacts that would not conventionally be available to sidecar investors 906 or investment targets 920, and some embodiments facilitate the transmission of this sort of advice and contacts between primary investors 916 and sidecar investors 916 through investment and management entity 902. Angel groups are generally local organizations made up of 10 to 150 accredited investors (primary investors 916) interested in early-stage investing.

Primary investment entity 914 facilitates the ability of primary investors 916 to provide primary capital 918 to investment targets 920 in exchange for primary payment obligations 922 by providing primary investment vetting and reporting information 924 in exchange for primary fees 926, which may be provided to education and management entity 902 if management services for primary investment entity 914 are provided by education and management entity 902. When investment targets 920 provide primary investment payments 946 to primary investors 916, those primary investment payments 946 may or may not flow through primary investment entity 914.

In addition to providing investment education services 904 to sidecar investors 906, education and management entity 902 receives sidecar investment vetting and reporting information 928 from primary investment entity 914. Education and management entity 902 then provides sidecar investment vetting and reporting information 930 to sidecar investors 906 and receives investment decision input 932 from sidecar investors 906. Based at least in part upon investment decision input 932 from sidecar investors 906, education and management entity 902 communicates investment decision instructions 934 to sidecar investment entity 910. Education and management entity 902 receives investment reports 936 from sidecar investment entity 910. Sidecar investment entity 910 provides sidecar capital 938 to investment targets 920 in exchange for sidecar payment obligations 940. When investment targets 920 provide sidecar investment payments 942 to sidecar investment entity 910, sidecar investment entity provides sidecar returns 944 to sidecar investors 906.

### Example System

Embodiments of a system and method for facilitating investor education as described herein may be executed on one or more computer systems, which may interact with various other devices. One such computer system is illustrated by FIG. 10. In different embodiments, computer system 1000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for embodiments of a transaction management module are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 12, memory 1020 may include program instructions 1025, configured to implement embodiments of a transaction management module as described herein, and data storage 1035, comprising various data accessible by program instructions 1025. In one embodiment, program instructions 1025 may include software elements of embodiments of a transaction management module as illustrated in the above Figures. Data storage 1035 may include data that may be used in embodiments. In other embodiments, other or different software elements and data may be included.

Those skilled in the art will appreciate that computer system 1000 is merely illustrative and is not intended to limit the scope of a transaction management module as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A method, comprising:
performing, using one or more processors,
providing an education service to investors in an investment entity;
providing to the set of investors vetting information regarding investment targets of the investment entity; and
responsive to receiving investment decision input from ones of the set of investors, providing investment decision instructions to the investment entity with respect to the investment targets.

2. The method of claim 1, further comprising
providing to the set of investors investment reports regarding investments in the investment targets of the investment entity.

3. The method of claim 1, wherein
the providing to the set of investors the vetting information regarding the investment targets of the investment entity further comprises providing to the set of investors vetting information received from another investment entity.

4. The method of claim 1, wherein
the providing to the set of investors the vetting information regarding the investment targets of the investment entity further comprises
providing to the set of investors vetting information received from an angel network that is facilitating investing in startup companies; and
providing investment decision instructions to the investment entity with respect to the investment targets further comprises
providing investment decision instructions to a sidecar investment entity with respect to the startup companies.

5. The method of claim 1, wherein
the providing the education service to the investors in the investment entity further comprises
providing an online course series to the investors in an investment entity.

6. The method of claim 1, wherein
the receiving investment decision input from one of the set of investors further comprises
receiving votes from the ones of the set of investors regarding investment decision instructions for the investment entity to make investments in the investment targets.

7. The method of claim 1, wherein
the providing the education service to the investors in the investment entity further comprises
providing an online course series to the investors in an investment entity,
wherein
the providing the online course series further comprises providing a video series explaining investing concepts and a series of interactive measurement instruments for measuring mastery of concepts presented in the online course series.

8. A system, comprising:
at least one processor; and
a memory comprising program instructions, wherein the program instructions are executable by the at least one processor to:
provide an education service to investors in an investment entity;
provide to the set of investors vetting information regarding investment targets of the investment entity; and
responsive to receiving investment decision input from ones of the set of investors, provide investment decision instructions to the investment entity with respect to the investment targets.

9. The system of claim 8, further comprising
program instructions executable by the at least one processor to provide to the set of investors investment reports regarding investments in the investment targets of the investment entity.

10. The system of claim 8, wherein
the program instructions executable by the at least one processor to provide to the set of investors the vetting information regarding the investment targets of program instructions executable by the at least one processor to provide to the set of investors vetting information received from another investment entity.

11. The system of claim 8, wherein
the program instructions executable by the at least one processor to provide to the set of investors the vetting information regarding the investment targets of the investment entity further comprise
program instructions executable by the at least one processor to provide to the set of investors vetting information received from an angel network that is facilitating investing in startup companies; and
the program instructions executable by the at least one processor to provide investment decision instructions to the investment entity with respect to the investment targets further comprise
program instructions executable by the at least one processor to provide investment decision instructions to a sidecar investment entity with respect to the startup companies.

12. The system of claim 8, wherein
the program instructions executable by the at least one processor to providing the education service to the investors in the investment entity further comprise
program instructions executable by the at least one processor to provide an online course series to the investors in an investment entity.

13. The system of claim 8, wherein
the program instructions executable by the at least one processor to receive investment decision input from one of the set of investors further comprise
program instructions executable by the at least one processor to receive votes from the ones of the set of investors regarding investment decision instructions for the investment entity to make investments in the investment targets.

14. The system of claim 8, wherein
the program instructions executable by the at least one processor to provide the education service to the investors in the investment entity further comprise
program instructions executable by the at least one processor to provide an online course series to the investors in an investment entity,
wherein
the program instructions executable by the at least one processor to provide the online course series further comprises program instructions executable by the at least one processor to provide a video series explaining investing concepts and a series of interactive measurement instruments for measuring mastery of concepts presented in the online course series.

15. A non-transitory computer-readable storage medium storing program instructions, wherein the program instructions are computer-executable to implement:
providing an education service to investors in an investment entity;
providing to the set of investors vetting information regarding investment targets of the investment entity; and
responsive to receiving investment decision input from ones of the set of investors, providing investment decision instructions to the investment entity with respect to the investment targets.

16. The non-transitory computer-readable storage medium of claim 15, further comprising
program instructions computer-executable to implement providing to the set of investors investment reports regarding investments in the investment targets of the investment entity.

17. The non-transitory computer-readable storage medium of claim 15, wherein
the program instructions computer-executable to implement providing to the set of investors the vetting information regarding the investment targets of the investment entity further comprise program instructions computer-executable to implement providing to the set of investors vetting information received from another investment entity.

18. The non-transitory computer-readable storage medium of claim 15, wherein
the program instructions computer-executable to implement providing to the set of investors the vetting information regarding the investment targets of the investment entity further comprise
program instructions computer-executable to implement providing to the set of investors vetting information received from an angel network that is facilitating investing in startup companies; and
the program instructions computer-executable to implement providing investment decision instructions to the investment entity with respect to the investment targets further comprise
program instructions computer-executable to implement providing investment decision instructions to a sidecar investment entity with respect to the startup companies.

19. The non-transitory computer-readable storage medium of claim 15, wherein
the program instructions computer-executable to implement providing the education service to the investors in the investment entity further comprise
program instructions computer-executable to implement providing an online course series to the investors in an investment entity.

20. The non-transitory computer-readable storage medium of claim 15, wherein
the program instructions computer-executable to implement receiving investment decision input from one of the set of investors further comprise
program instructions computer-executable to implement receiving votes from the ones of the set of investors regarding investment decision instructions for the investment entity to make investments in the investment targets.
